(19) United States
(12) Patent Application Publication
(10) Pub. No.: US 2017/0288194 A1
(43) Pub. Date: Oct. 5, 2017

(54) ELECTRICITY STORAGE DEVICE

(71) Applicant: KABUSHIKI KAISHA TOYOTA JIDOSHOKKI, Kariya-shi, Aichi-ken (JP)

(72) Inventors: Atsushi MINAGATA, Kariya-shi (JP); Motoaki OKUDA, Kariya-shi (JP)

(73) Assignee: KABUSHIKI KAISHA TOYOTA JIDOSHOKKI, Kariya-shi, Aichi-ken (JP)

(21) Appl. No.: 15/512,157

(22) PCT Filed: Sep. 17, 2015
(86) PCT No.: PCT/JP2015/076559

§ 371 Date: Mar. 17, 2017

(30) Foreign Application Priority Data
Sep. 22, 2014 (JP) 2014-192593

(51) Int. Cl. H01M 2/16; H01M 10/0525; H01G 11/78; H01G 11/52; H01G 11/22

(52) U.S. Cl. CPC H01M 2/1673; H01G 11/52; H01G 11/22; H01G 11/78; H01M 10/0525; H01M 2220/20

(57) ABSTRACT

An electrode assembly of a rechargeable battery is configured by stacking electrode-accommodating separators, each accommodating a positive electrode, and negative electrodes. A case has rectangular long side walls facing flat surfaces of the electrode assembly. Also, the electrode-accommodating separator has stretchabilities according to directions, and has a direction in which the stretchability is higher than in other directions. The electrode-accommodating separators are arranged such that the direction along which the stretchability is high is aligned with the direction with which the long sides of the long side walls are aligned.

### TECHNICAL FIELD

The present invention relates to an electricity storage device.

### BACKGROUND ART

Vehicles such as electric vehicles (EV) and plug-in hybrid vehicles (PHV) include rechargeable batteries such as lithium-ion batteries. The rechargeable batteries are used as electricity storage devices that store electric power supplied to a motor, which is a drive source. For example, a rechargeable battery disclosed in Patent Document 1 includes an electrode assembly and a case. The electrode assembly includes positive electrodes and negative electrodes stacked on one another with separators located in between. The positive electrodes and negative electrodes have active material layers. The case accommodates the electrode assembly. The rechargeable battery disclosed in Patent Document 1 includes rectangular flat surfaces on opposite ends in a stacking direction of the electrode assembly. The walls of the case that face the flat surfaces are rectangular and have long sides and short sides.

### PRIOR ART DOCUMENT

### Patent Document

### Patent Document 1: Japanese Laid-Open Patent Publication No. 09-120836

### SUMMARY OF THE INVENTION

### Problems that the Invention is to Solve

In the rechargeable battery in which the walls that face the flat surfaces of the electrode assembly are rectangular, pressure may be applied to the walls from the outside in the stacking direction of the electrode assembly. In this case, the walls of the case are likely to be bent in a state in which the outer surfaces of the walls are bent in the middle of the long sides. Then, the electrode assembly accommodated in the case is likely to be bent in a state in which the flat surfaces are bent in the middle of the long sides. If the electrode assembly is bent in this manner, the separators are also bent in accordance with the bending of the electrode assembly. The bending may possibly cause the separators to be damaged, resulting in a short circuit between the positive electrodes and the negative electrodes at the damaged sections.

It is an objective of the present invention to provide an electricity storage device that prevents damage from occurring in separators when the separators are bent.

### Means for Solving the Problems

Hereinafter, means for achieving the above-described objective and operational advantages will be described.

To achieve the foregoing objective and in accordance with one aspect of the present invention, an electricity storage device that includes an electrode assembly and a case is provided. The electrode assembly is configured by stacking two electrodes each having an active material layer and a separator located between the electrodes. The electrode assembly has rectangular flat surfaces on opposite ends in a stacking direction. The case accommodates the electrode assembly. The case includes rectangular walls that face the flat surfaces of the electrode assembly, and the separator has stretchabilities according to directions. The stretchability of the separator in a longitudinal direction is higher than the stretchability in a transverse direction.

With the above-mentioned configuration, pressure may be applied to the walls of the case from the outside in the stacking direction of the electrode assembly. In this case, the walls of the case are likely to be bent in a state in which the outer surfaces of the walls are bent in the middle of the long sides. Simultaneously, the electrode assembly is bent in a state in which the flat surfaces are bent in the middle of the long sides. The separator is also bent in accordance with the bending of the electrode assembly. However, the longitudinal direction of the separator along the long sides of the bent walls has a stretchability that is higher than the stretchability in the transverse direction. Thus, the separator is flexibly stretched in accordance with the bending. This prevents damage such as cracks from occurring in the separator.

In the electricity storage device, the separator includes a direction in which the stretchability of the separator is higher than the stretchabilities in other directions. The separator is arranged such that the direction in which the stretchability is high is aligned with the direction with which long sides of the walls are aligned.

With this configuration, the longitudinal direction of the separator that is aligned with the long sides of the bent walls has the highest stretchability in the separator. Thus, the separator flexibly is stretched in accordance with the bending in a more suitable manner. This prevents damage such as cracks from occurring in the separator.

In the electricity storage device, the separator is an electrode-accommodating separator, which sandwiches one of the electrodes from opposite sides in the stacking direction to accommodate the electrode inside the separator.

With this configuration, the electrode-accommodating separator includes a portion that protrudes from the outline of the sandwiched electrode. When the electrode-accommodating separator is bent together with the case, the portion of the electrode-accommodating separator that protrudes from the outline of the sandwiched electrode gets caught on the edges of the electrode. Thus, the electrode-accommodating separator is likely to be pulled greatly. In this respect, although the electrode-accommodating separator that is pulled greatly as described above is located in the electrode assembly, the above-described configuration prevents damage such as cracks from occurring in the electrode-accommodating separator.

In the electricity storage device, the separator is configured by coupling separator members, which are opposed to each other with one of the electrodes sandwiched in between from the stacking direction. Each separator member includes a protruding portion, which protrudes from an outline of the sandwiched electrode. The separator includes a coupling portion, which couples at least a part of the protruding portions that are opposed to each other.

With this configuration, while the separator is bent together with the case, the electrode sandwiched between the separator members is also bent. The coupling portion, which couples the separator members, gets caught on the edges of the electrode, and the electrode and the separator members are bent. Thus, the sandwiched electrode is prevented from moving with respect to the separator members in the plane direction and protruding from between the separator members. This prevents a short circuit between the electrodes.

In the electricity storage device, an outline of the separator is aligned with an outline of the electrode that is not accommodated inside the separator as viewed from the stacking direction.

With this configuration, when the outline of the separator is aligned with the outline of the electrode that is not accommodated inside the separator, the outline of the separator does not protrude from the outline of the electrode that is not accommodated in the separator. In this state, for example, if the configuration includes a separate member coupled to an edge of the separator, the separate member is located inward of the outline of the electrode assembly. This configuration undesirably increases a section that does not contribute to the performance of the electricity storage device by the amount corresponding to the size of the separate member located inward of the outline. If the separate member that is coupled to the edge of the separator is located outward of the outline of the electrode assembly, the outline of the separator undesirably protrudes from the outline of the electrode that is not accommodated in the separator. Thus, the state in which the outline of the separator is aligned with the outline of the electrode that is not accommodated in the separator indicates that the separator does not include the separate member at the edge of the separator. With regard to the longitudinal direction in which the stretchability of the separator is high, the stretchability is not decreased by, for example, the separate member. Thus, when the separator is bent together with the case, stretching of the separator is not hindered.

In the electricity storage device, an edge of the separator is exposed.

With this configuration, the separator includes no separate member at the peripheral portion along the edge of the separator. With regard to the longitudinal direction, in which the stretchability of the separator is high, the stretchability is not decreased by, for example, a separate member. Thus, when the separator is bent together with the case, stretching of the separator is not hindered.

In the electricity storage device, the electrodes include a negative electrode, and the separator and the negative electrode are located in a range in which the separator and the negative electrode do not overlap as viewed in a plane direction of the negative electrode.

With this configuration, the separator includes no separate member that is coupled to the peripheral portion. With regard to the longitudinal direction, in which the stretchability of the separator is high, the stretchability is not decreased by a separate member. Thus, when the separator is bent together with the case, stretching of the separator is not hindered.

In the above-described electricity storage device, a preferred embodiment of the electricity storage device includes a rechargeable battery.

### Effects of the Invention

The present invention prevents damage from occurring in the separators when the electricity storage device is bent.

### BRIEF DESCRIPTION OF THE DRAWINGS

FIG. 1 is a perspective view of a rechargeable battery, illustrating the external appearance.

FIG. 2 is an exploded perspective view of components of the electrode assembly.

FIG. 3 is a cross-sectional view of the rechargeable battery illustrating the inside of the rechargeable battery.

FIG. 4 is a cross-sectional view taken along line 4-4 of FIG. 1, illustrating the inside of the rechargeable battery.

### MODES FOR CARRYING OUT THE INVENTION

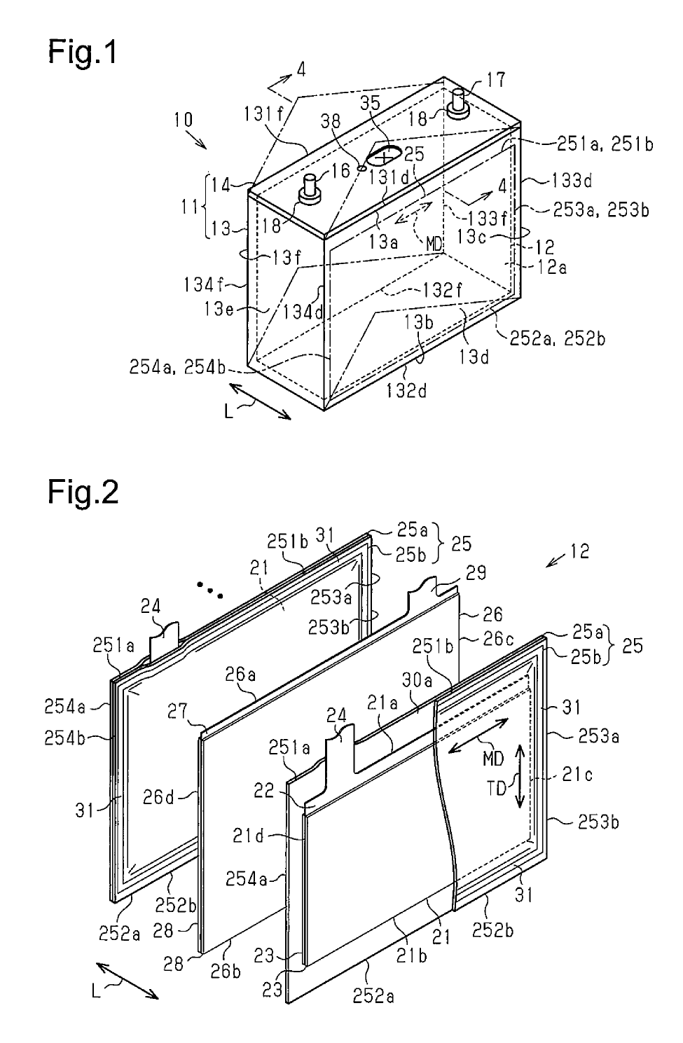

An electricity storage device according to one embodiment will now be described with reference to FIGS. 1 to 4.

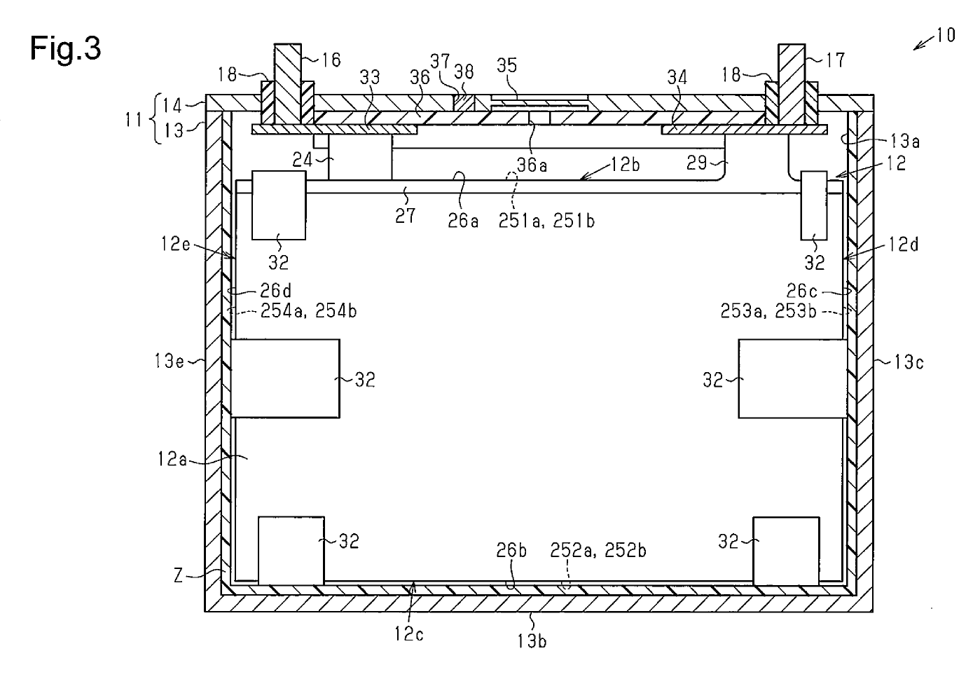

As shown in FIGS. 1 and 3, an electricity storage device, which is a rechargeable battery 10 in this embodiment, includes a case 11 and an electrode assembly 12 accommodated in the case 11. The case 11 also accommodates an electrolyte solution together with the electrode assembly 12. The case 11 includes a tubular case body 13 with a closed end and a flat plate-shaped lid 14. The case body 13 includes a rectangular opening 13a. The electrode assembly 12 is inserted in the case body 13 through the opening 13a. The lid 14 closes the rectangular opening 13a. The inner surface of the case body 13 is coated with an insulating film Z. The case body 13 and the electrode assembly 12 are insulated from each other by the insulating film Z.

The lid 14 includes a pressure release valve 35. When the pressure in the case 11 reaches a release pressure, which is a predetermined pressure, the pressure release valve 35 ruptures such that the pressure in the case 11 is not excessively increased and allows the inside and the outside of the case 11 to communicate each other. The release pressure of the pressure release valve 35 is set to a pressure that allows the pressure release valve 35 to rupture before a crack or a breakage occurs in the case 11 itself, the case body 13, or the lid 14. The lid 14 also includes a filler opening 37 for pouring the electrolyte solution into the case 11. The filler opening 37 is sealed with a sealing plug 38.

The electrode assembly 12 is electrically connected to a positive terminal 16 and a negative terminal 17. Each of the terminals 16, 17 has a ring-shaped insulating ring 18. The insulating rings 18 insulate the terminals 16, 17 from the case 11. Part of the terminals 16, 17 are exposed to the outside of the case 11 through the through-holes in the lid 14.

The case body 13 includes a rectangular bottom wall 13b. The bottom wall 13b faces the opening 13a. The case body 13 includes long side walls 13d, 13f. The long side walls 13d, 13f are rectangular as viewed from the front and extend upright from the long side edges of the bottom wall 13b. The case body 13 includes short side walls 13c, 13e. The short side walls 13c, 13e are rectangular as viewed from the front and extend upright from the short side edges of the bottom wall 13b. The case body 13 and the lid 14 are both made of metal (for example, stainless-steel or aluminum). The case body 13 of the rechargeable battery 10 of the present embodiment is shaped like a rectangular tube with one closed end.

Long sides 131d, 131f of the long side walls 13d, 13f are the long sides of the opening 13a, and long sides 132d, 132f of the long side walls 13d, 13f are connected to the long sides of the bottom wall 13b. The short sides 133d, 134d of the long side wall 13d and the short sides 133f, 134f of the long side wall 13f are connected to the short side walls 13c, 13e.

Since the lid 14 is shaped like a rectangular flat plate, the rechargeable battery 10 is a nine-volt battery having a rectangular external appearance. The rechargeable battery 10 of the present embodiment is a lithium-ion battery.

As shown in FIG. 2, the electrode assembly 12 includes electrode-accommodating separators 25 and negative electrodes 26. The electrode-accommodating separators 25 each accommodate an electrode, which is a positive electrode 21 in this embodiment. The negative electrodes 26 are electrodes having a different polarity from the positive electrodes 21. The electrode assembly 12 has a laminated structure in which the electrode-accommodating separators 25 and the negative electrodes 26 are stacked alternately. Thus, the positive electrodes 21 and the negative electrodes 26 are stacked alternately with the electrode-accommodating separators 25 located in between. In the present embodiment, the positive electrodes 21, the electrode-accommodating separators 25, and the negative electrodes 26 each have a rectangular shape.

Each positive electrode 21 includes a sheet of rectangular positive-electrode metal foil (for example, aluminum foil) 22 and positive-electrode active material layers 23. The positive-electrode active material layers 23 include positive-electrode active material and are located on the opposite sides of the positive-electrode metal foil 22. A positive-electrode tab 24 projects from a long side 21a of the positive electrode 21.

Each negative electrode 26 includes a sheet of rectangular negative-electrode metal foil (for example, copper foil) 27 and negative-electrode active material layers 28. The negative-electrode active material layers 28 include negative-electrode active material and are located on the opposite sides of the negative-electrode metal foil 27. A negative-electrode tab 29 projects from a long side 26a of the negative electrode 26.

Each electrode-accommodating separator 25 is configured by coupling a rectangular first separator member 25a and a rectangular second separator member 25b, which are opposed to each other. The first separator member 25a and the second separator member 25b are both made of insulating plastic (for example, polyethylene). The first separator member 25a and the second separator member 25b are manufactured by cutting an elongated rectangle of separator sheet material into desired sizes.

In the present embodiment, the separator sheet material is manufactured by uniaxial stretching in which the separator material is stretched in one direction. The first separator member 25a and the second separator member 25b are uniaxially oriented films. That is, the electrode-accommodating separators 25 are made of uniaxially oriented films. Thus, fibers in the first separator members 25a and the second separator members 25b are oriented in a machine direction at the time of manufacturing, that is, in an MD direction. In the first separator members 25a and the second separator members 25b, a direction that intersects (is orthogonal to) the MD direction is defined as a TD direction. The first separator members 25a and the second separator members 25b have stretchabilities according to directions. Since the fibers are oriented in the MD direction, the stretchability of the first separator members 25a and the second separator members 25b is higher in the MD direction than in the TD direction. That is, the first separator members 25a and the second separator members 25b have a direction (MD direction) in which the stretchability is higher than in other directions (TD direction). In other words, the first separator members 25a and the second separator members 25b have the highest stretchability in the MD direction.

In the first separator members 25a of the present embodiment, the MD direction, in which the stretchability is high, is aligned with the direction with which long sides 251a, 252a are aligned. The MD direction of the second separator members 25b are aligned with the direction with which long sides 251b, 252b are aligned. In the first separator members 25a, the TD direction, in which the stretchability is lower than the stretchability in the MD direction, is aligned with the direction with which short sides 253a, 254a of the first separator members 25a are aligned. The TD direction of the second separator members 25b is aligned with short sides 253b, 254b.

Thus, in each electrode-accommodating separator 25, in which the first separator member 25a and the second separator member 25b are coupled to each other, the stretchability in the longitudinal direction along the long sides 251a, 251b, 252a, 252b is higher than the stretchability in the transverse direction (other directions) along the short sides 253a, 253b, 254a, 254b. Since the electrode-accommodating separator 25 has only the transverse direction besides the longitudinal direction, the stretchability of the longitudinal direction is the highest.

The sizes of the first separator members 25a and the second separator members 25b are the same and are slightly larger than the positive electrodes 21. In each electrode-accommodating separator 25, the long side 251a of the first separator member 25a, the long side 251b of the second separator member 25b, and the long side 21a of the positive electrode 21 are aligned. In each electrode-accommodating separator 25, the long side 252a of the first separator member 25a, the long side 252b of the second separator member 25b, and a long side 21b of the positive electrode 21 are aligned.

Furthermore, in each electrode-accommodating separator 25, the short side 253a of the first separator member 25a, the short side 253b of the second separator member 25b, and a short side 21c of the positive electrode 21 are aligned. Similarly, in each electrode-accommodating separator 25, the short side 254a of the first separator member 25a, the short side 254b of the second separator member 25b, and a short side 21d of the positive electrode 21 are aligned.

The first separator member 25a and the second separator member 25b each include a protruding portion 30a. The protruding portions 30a protrude from the long sides 21a, 21b and the short sides 21c, 21d, which constitute the outline of the positive electrode 21. Each electrode-accommodating separator 25 includes a coupling portion, which is a joint 31 in this embodiment. The joint 31 is configured by coupling the protruding portion 30a of the first separator member 25a and the protruding portion 30a of the second separator member 25b, which face each other, by welding. The joint 31 couples the first separator member 25a and the second separator member 25b on four sides. The joint 31 is configured by welding the entire protruding portions 30a along the four sides, which constitute the outline of the positive electrode 21, except a section opposed to the positive-electrode tab 24.

The positive-electrode tab 24 of the positive electrode 21 is located between the surfaces of the protruding portions 30a, which are the opposed surfaces of the first separator member 25a and the second separator member 25b, and extends between the surfaces to protrude beyond the long sides 251a, 251b of the first separator member 25a and the second separator member 25b. In each electrode-accommodating separator 25, the first separator member 25a and the second separator member 25b are joined so that the part inward of the joint 31 serves as an accommodating portion for an electrode.

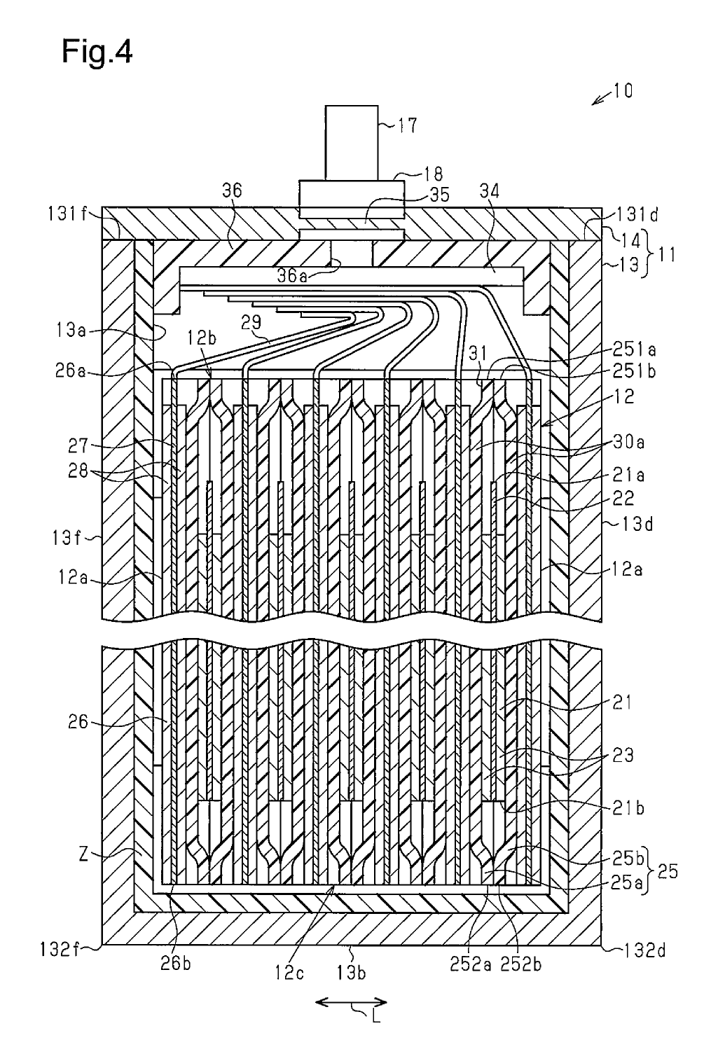

As shown in FIG. 4, the negative electrodes 26 and the electrode-accommodating separators 25 are stacked such that the long sides 26a of the negative electrodes 26, the long sides 251a of the first separator members 25a, and the long sides 251b of the second separator members 25b are aligned. The long sides 26a, 251a, 251b are on the same plane. The edges of the electrode-accommodating separators 25 along the long sides 251a of the first separator members 25a and the long sides 251b of the second separator members 25b are exposed in the case 11. The electrode assembly 12 includes a tab side end face 12b. The exposed edges including the long sides 251a of the first separator members 25a, the long sides 251b of the second separator members 25b, and the long sides 26a of the negative electrodes 26 are collected at the tab side end face 12b.

Similarly, the negative electrodes 26 and the electrode-accommodating separators 25 are stacked such that long sides 26b of the negative electrodes 26, the long sides 252a of the first separator members 25a, and the long sides 252b of the second separator members 25b are aligned. The long sides 26b, 252a, 252b are on the same plane. The edges of the electrode-accommodating separators 25 along the long sides 252a of the first separator members 25a and the long sides 252b of the second separator members 25b are exposed in the case 11. The electrode assembly 12 includes a bottom side end face 12c. The exposed edges including the long sides 252a of the first separator members 25a, the long sides 252b of the second separator members 25b, and the long sides 26b of the negative electrodes 26 are collected at the bottom side end face 12c.

When the tab side end face 12b is viewed in a plane direction from the side corresponding to the tab side end face 12b toward the bottom side end face 12c along the surfaces of the negative electrodes 26, the electrode-accommodating separators 25 and the negative electrodes 26 are located in a range in which these do not overlap. Similarly, when the bottom side end face 12c is viewed in a plane direction from the side corresponding to the bottom side end face 12c toward the tab side end face 12b along the surfaces of the negative electrodes 26, the electrode-accommodating separators 25 and the negative electrodes 26 are located in a range in which these do not overlap.

As shown in FIG. 3, the negative electrodes 26 and the electrode-accommodating separators 25 are stacked such that the short sides 26c of the negative electrodes 26, the short sides 253a of the first separator members 25a, and the short sides 253b of the second separator members 25b are aligned. The short sides 26c, 253a, 253b are on the same plane. The edges of the electrode-accommodating separators 25 along the short sides 253a of the first separator members 25a and the short sides 253b of the second separator members 25b are exposed in the case 11. The electrode assembly 12 includes a first side end face 12d. The exposed edges including the short sides 253a of the first separator members 25a, the short sides 253b of the second separator members 25b, and the short sides 26c of the negative electrode 26 are collected at the first side end face 12d.

Similarly, the negative electrodes 26 and the electrode-accommodating separators 25 are stacked such that the short sides 26d of the negative electrodes 26, the short sides 254a of the first separator members 25a, short sides 254b of the second separator members 25b are aligned. The short sides 26d, 254a, 254b are on the same plane. The edges of the electrode-accommodating separators 25 along the short sides 254a of the first separator members 25a and the short sides 254b of the second separator members 25b are exposed in the case 11. The electrode assembly 12 includes a second side end face 12e. The exposed edges including the short sides 254a of the first separator members 25a, the short sides 254b of the second separator members 25b, and the short sides 26d of the negative electrodes 26 are collected at the second side end face 12e.

When the first side end face 12d is viewed in a plane direction from the side corresponding to the first side end face 12d toward the second side end face 12e along the surfaces of the negative electrodes 26, the electrode-accommodating separators 25 and the negative electrodes 26 are located in a range in which these do not overlap. Similarly, when the second side end face 12e is viewed in a plane direction from the side corresponding to the second side end face 12e toward the first side end face 12d along the surfaces of the negative electrodes 26, the electrode-accommodating separators 25 and the negative electrodes 26 are located in a range in which these do not overlap.

In the electrode assembly 12, the tabs 24, 29 of the electrodes 21, 26 having the same polarity are arranged in a row in a stacking direction L. The negative electrodes 26 and the electrode-accommodating separators 25 of the electrode assembly 12 are stacked such that the tabs having different polarities do not overlap each other in the stacking direction L.

As shown in FIGS. 1 and 4, when the direction in which the electrode-accommodating separators 25 and the negative electrodes 26 are stacked in the electrode assembly 12 is referred to as the stacking direction L, the electrode assembly 12 includes flat surfaces 12a on the opposite ends in the stacking direction L. The flat surfaces 12a are configured by the surfaces of the negative electrodes 26 located at the ends in the stacking direction L. Since the negative electrodes 26 are rectangular, the flat surfaces 12a are rectangular when viewed from the front. The long side walls 13d, 13f of the case body 13 face the flat surfaces 12a.

As shown in FIG. 3, when the electrode assembly 12 is viewed from the stacking direction L, the outline of the negative electrodes 26, which is not accommodated in the electrode-accommodating separators 25, is aligned with the outline of the electrode-accommodating separators 25. More specifically, when the electrode assembly 12 is viewed from the stacking direction L, the long sides 26a of the negative electrodes 26, the long sides 251a of the first separator members 25a, and the long sides 251b of the second separator members 25b are aligned with one another. When the electrode assembly 12 is viewed from the stacking direction L, the long sides 26b of the negative electrodes 26, the long sides 252a of the first separator members 25a, and the long sides 252b of the second separator members 25b are also aligned with one another. However, it is only required that either of the opposite long sides of each negative electrode 26 is aligned with the corresponding long side of each electrode-accommodating separator 25 as viewed in the stacking direction L.

The electrode assembly 12 is maintained in a state in which the displacement of the negative electrodes 26 and the electrode-accommodating separators 25 is restricted by holding tapes 32 in the stacking direction and in a direction along the flat surfaces 12a.

In the electrode assembly 12, it is assumed that a direction along the tab side end face 12b and in which the positive-electrode tabs 24 and the negative-electrode tabs 29 are arranged is an arrangement direction. Some of the holding tapes 32 are adhered to the tab side end face 12b outward of the positive-electrode tabs 24 and the negative-electrode tabs 29 in the arrangement direction. The holding tapes 32 further extend from the tab side end face 12b to be adhered to the opposite flat surfaces 12a. Some of the holding tapes 32 are adhered to the bottom side end face 12c on the opposite end sections in the arrangement direction and further extend from the bottom side end face 12c to be adhered to the opposite flat surfaces 12a. In addition, the other holding tapes 32 are adhered to the first side end face 12d and the second side end face 12e and extend to be adhered to the flat surfaces 12a. The bottom side end face 12c, the first side end face 12d, and the second side end face 12e of the electrode assembly 12 face the inner surface of the case body 13 via the holding tapes 32 and the insulating film Z.

The positive-electrode tabs 24 are electrically connected to the positive terminal 16 via a positive-electrode conductive member 33. The negative-electrode tabs 29 are electrically connected to the negative terminal 17 via a negative-electrode conductive member 34.

The rechargeable battery 10 includes an insulating cover 36. The insulating cover 36 is located between the lid 14 and the set of the positive-electrode conductive member 33 and the negative-electrode conductive member 34. The insulating cover 36 faces the tab side end face 12b in a state in which the electrode assembly 12 is accommodated in the case body 13 and the lid 14 is joined. The insulating cover 36 is made of, for example, plastic. The insulating cover 36 includes a communication hole 36a. The communication hole 36a is bored in a section facing the pressure release valve 35.

In the tab side end face 12b of the electrode assembly 12, the long sides 251a, 251b of the electrode-accommodating separators 25 and the long sides 26a of the negative electrodes 26 are opposed to the insulating cover 36. Only a space is provided between the tab side end face 12b and the insulating cover 36. In the bottom side end face 12c, the long sides 252a, 252b of the electrode-accommodating separators 25 and the long sides 26b of the negative electrodes 26 are directly supported by the inner bottom surface of the case body 13 via the insulating film Z.

In the rechargeable battery 10, the long sides 26a of the negative electrodes 26, the long sides 251a of the first separator members 25a, and the long sides 251b of the second separator members 25b are substantially parallel with the long sides of the lid 14. The long sides 26b of the negative electrodes 26, the long sides 252a of the first separator members 25a, and the long sides 252b of the second separator members 25b are substantially parallel with the bottom wall 13b of the case body 13.

As shown in FIG. 1, in the rechargeable battery 10, the direction with which the long sides 131d, 131f, 132d, 132f of the long side walls 13d, 13f of the case body 13 are aligned is parallel with the MD direction of the first separator members 25a and the second separator members 25b. That is, the electrode-accommodating separators 25 are arranged with the MD direction, in which the stretchability is high, aligned with the direction with which the long sides 131d, 131f, 132d, 132f of the long side walls 13d, 13f are aligned. More specifically, the direction with which the long sides 131d, 131f, 132d, 132f of the long side walls 13d, 13f are aligned is parallel with the MD direction of the first separator members 25a and the second separator members 25b. The state in which the direction with which the long sides 131d, 131f, 132d, 132f are aligned is parallel with the MD direction of the first and second separator members 25a, 25b also includes a state in which one of the direction with which the long sides 131d, 131f, 132d, 132f are aligned and the MD direction of the first and second separator members 25a, 25b is slightly inclined with respect to the other.

Operation of the rechargeable battery 10 of the present embodiment will now be described.

When pressure is applied to the rechargeable battery 10 from the outside of the long side walls 13d, 13f, which are rectangular, in the stacking direction L, the long side walls 13d, 13f are likely to bend so that the outer surfaces are bent in the middle of the long sides 131d, 131f, 132d, 132f as shown by the long dashed double-short dashed lines in FIG. 1. This causes the electrode assembly 12 to also bend so that the flat surfaces 12a are bent in the middle of the long sides. At this time, the electrode-accommodating separators 25 are also bent so that the long sides 251a, 251b, 252a, 252b are bent in the middle. However, since the longitudinal direction with which the long sides 251a, 251b, 252a, 252b of the electrode-accommodating separators 25 are aligned is the MD direction, the stretchability is higher than the stretchability in the transverse direction with which the short sides 253a, 253b, 254a, 254b are aligned. Thus, the electrode-accommodating separators 25 are stretched freely in accordance with the bending of the electrode assembly 12.

The present embodiment achieves the following advantages.

(1) The longitudinal direction of the electrode-accommodating separators 25 is the MD direction, in which the stretchability is high. The electrode-accommodating separators 25 are arranged such that the MD direction is aligned with the direction with which the long sides 131d, 131f, 132d, 132f of the long side walls 13d, 13f of the case body 13 are aligned. Thus, even if the long side walls 13d, 13f of the case 11 are bent so that the outer surfaces bend in the middle of the long sides 131d, 131f, 132d, 132f, and the flat surfaces 12a of the electrode assembly 12 are also bent in the same manner, the first separator members 25a and the second separator members 25b are stretched in accordance with the bending in a suitable manner. This configuration prevents damage such as cracks from occurring in the electrode-accommodating separators 25.

(2) Each electrode-accommodating separator 25 includes the joint 31 between the first separator member 25a and the second separator member 25b. The joint 31 is located around the accommodating portion, which accommodates the associated positive electrode 21. When the case 11 and the electrode assembly 12 are bent, the joint 31 of each electrode-accommodating separator 25 described above is likely to get caught on the short sides 21c, 21d of the positive electrode 21, and the long sides 251a, 251b, 252a, 252b are likely to be pulled greatly. However, since the MD direction of the electrode-accommodating separator 25, in which the stretchability is high, is aligned with the direction with which the long sides 251a, 251b, 252a, 252b are aligned, damage such as cracks are prevented from occurring in the electrode-accommodating separator 25.

When the case 11 and the electrode assembly 12 are bent, each joint 31 gets caught on the short sides 21c, 21d of the associated positive electrode 21, causing the positive electrode 21 to also bend following the electrode-accommodating separator 25. This configuration prevents each positive electrode 21 from moving in the plane direction with respect to the first separator member 25a and the second separator member 25b, prevents the positive electrode 21 from protruding from between the first separator member 25a and the second separator member 25b, and thus prevents a short circuit between the positive electrode 21 and the negative electrode 26.

(3) In each electrode-accommodating separator 25, the long sides 251a, 251b, 252a, 252b, which are aligned with the MD direction, in which the stretchability is high, are movable relative to the insulating cover 36 and the bottom wall 13b. Thus, when the electrode-accommodating separator 25 is bent together with the case 11, the first separator member 25a and the second separator member 25b are not hindered from being stretched and are stretched in accordance with the bending in a suitable manner. The edges of the electrode-accommodating separators 25 corresponding to the long sides 251a, 251b, 252a, 252b are exposed in the case 11. Furthermore, when the electrode assembly 12 is viewed from the side corresponding to any of the tab side end face 12b, the bottom side end face 12c, the first side end face 12d, and the second side end face 12e along the plane direction of the negative electrodes 26, the electrode-accommodating separators 25 and the negative electrodes 26 are located in a range in which these do not overlap. Thus, a separate member for changing the stretchability is not attached to the long sides 251a, 251b, 252a, 252b of the electrode-accommodating separators 25. For this reason, when the electrode-accommodating separators 25 are bent together with the case 11, the first separator members 25a and the second separator members 25b are not hindered from being stretched, and the electrode-accommodating separators 25 are stretched in accordance with the bending in a suitable manner. In addition, a space for accommodating a separate member does not need to be provided in the case 11, and an unused space that does not contribute to the battery performance is eliminated.

The above described embodiment may be modified as follows.

In the electrode-accommodating separators 25, as long as the stretchability in the longitudinal direction is higher than the stretchability in the transverse direction, the direction in which the stretchability is high may be different from the direction along the long sides 251a, 251b, 252a, 252b. That is, the direction in which the stretchability is the highest may be nonparallel with the long sides 251a, 251b, 252a, 252b.

The shape of the electrode-accommodating separators 25 may be other than rectangular as viewed from the front. In this case also, the electrode-accommodating separators 25 are arranged such that the longitudinal direction in which the stretchability is high is aligned with the direction with which the long sides of the wall portions that face the flat surfaces 12a are aligned.

The separator may be a sheet of elongated separator that is folded in half at the middle in the longitudinal direction. The positive electrode 21 or the negative electrode 26 may be sandwiched between the opposed parts of the folded separator. In this case, the parts that sandwich the positive electrode 21 or the negative electrode 26 serve as the separator members, and the folded portion serves as the coupling portion, which couples the separator members.

The separator may be configured with a sheet of elongated separator that is fan-folded at multiple positions in the longitudinal direction. The positive electrodes 21 or the negative electrodes 26 may be sandwiched between the opposed parts in the folded state.

In each electrode-accommodating separator 25, the entire protruding portions 30a along the four sides of the first separator member 25a and the second separator member 25b except a section opposed to the positive-electrode tab 24 is welded. However, it is only required that a part of the protruding portions 30a along each side is welded, or multiple positions of the protruding portions 30a along each side is welded to couple.

The electrode accommodated in each electrode-accommodating separator 25 may be changed to the negative electrode 26.

Instead of the electrode-accommodating separators 25, sheet-shaped separators may be employed. In this case, the sheet-shaped separators are provided between the positive electrodes 21 and the negative electrodes 26. In this case also, the separators are arranged such that the longitudinal direction (MD direction), in which the stretchability is high, is aligned with the direction with which the long sides 131d, 131f, 132d, 132f of the long side walls 13d, 13f of the case body 13 are aligned.

The separator sheet material for the first separator members 25a and the second separator members 25b of the electrode-accommodating separators 25 according to the above-described embodiment and the separator according to the above-described modification may be manufactured by biaxial stretching, in which the separator material is stretched in in two directions orthogonal to each other. If the stretchability in one of orthogonal biaxial directions along the surface of the separator is higher than the stretchability in the other direction, the direction in which the stretchability is high is set as the longitudinal direction of the separator and is arranged to be aligned with the direction with which the long sides 131d, 131f, 132d, 132f of the long side walls 13d, 13f of the case body 13 are aligned.

If the stretchability of the separator differs in three or more directions along the surface of the separator, one of the directions with the stretchabilities higher than in the direction in which the stretchability is the lowest is set as the longitudinal direction of the separator and is arranged to be aligned with the direction with which the long sides 131d, 131f, 132d, 132f of the long side walls 13d, 13f of the case body 13 are aligned.

The electrodes 21, 26 may be shaped into a form other than a rectangle. For example, the electrodes 21, 26 may be shaped into a trapezoid or a square.

The positive-electrode active material layer 23 may be provided on at least one side of the positive electrode 21.

The negative-electrode active material layer 28 may be provided on at least one side of the negative electrode 26.

The rechargeable battery 10 is a lithium-ion rechargeable battery in this embodiment. However, the rechargeable battery 10 may be other rechargeable batteries. That is, any configuration may be employed as long as ions move between the positive-electrode active material layer and the negative-electrode active material layer, and the positive-electrode active material layer and the negative-electrode active material layer give and receive electric charge.

The case 11 of the rechargeable battery 10 does not necessarily have to be made of metal. A laminate film may be used for the case. The present invention is also applicable to a laminate cell in which the electrode assembly is covered with a laminate film. In this case, the electrode assembly includes rectangular flat surfaces on the opposite ends in the stacking direction, and the walls of the laminate film facing the flat surfaces of the electrode assembly are rectangular. The separator is arranged such that the direction in which the stretchability is high is aligned with the direction with which the long sides of the walls of the laminate film that face the flat surfaces are aligned.

As long as the walls that face the flat surfaces 12a of the electrode assembly 12 are rectangular, the shape of the case 11 may be changed. For example, the case 11 may be a cylinder having an elliptical bottom wall. In this case, walls that extend upright from the long sides of the ellipse of the bottom wall face the flat surfaces of the electrode assembly and are rectangular.

A rolled body may be employed as the electrode assembly 12. The rolled body includes a band-shaped single positive electrode and a band-shaped single negative electrode that are rolled together. In the rechargeable battery 10 that includes the electrode assembly 12 in a rolled body, the separators are arranged such that the longitudinal direction, in which the stretchability is high, is aligned with the direction with which the long sides of the long side walls of the case are aligned. In general, when the rolled body is viewed along its central axis, the rolled body has an approximately elliptical shape. When the rolled body is viewed along its central axis, the direction in which the dimension is small is defined as a thickness direction, and the direction in which the dimension is great is defined as a width direction. In this modification, the stacking direction refers to the thickness direction.

The present invention may be embodied in an electricity storage device such as an electric double layer capacitor.

Technical ideas obtainable from the above embodiments and modifications other than those disclosed in the claim section are described below with their advantages.

(1) An electricity storage device, wherein the separator is made of a uniaxially oriented film.

(2) The electricity storage device comprising: an electrode assembly including electrodes and a separator, the electrodes includes an active material layer, the electrodes and the separator are stacked with the separator located between the electrodes, the electrode assembly includes rectangular flat surfaces on opposite ends in a stacking direction; and a case, which accommodates the electrode assembly, wherein the electricity storage device is characterized in that the case includes rectangular walls that face the flat surfaces of the electrode assembly, the separator has stretchabilities according to directions, the separator includes a direction in which the stretchability is higher than the stretchabilities of other directions, and the separator is arranged such that the direction in which the stretchability is high is parallel with the direction with which long sides of the walls are aligned.

### DESCRIPTION OF THE REFERENCE NUMERALS

10 . . . Electricity storage device, which is rechargeable battery in this embodiment, 11 . . . Case, 12 . . . Electrode assembly, 12a . . . Flat surface, 13d, 13f . . . Walls, which are long side walls in this embodiment, 21 . . . Electrode, which is positive electrode in this embodiment, 23 . . . Positive-electrode active material layer, 25 . . . Separator, which is electrode-accommodating separator in this embodiment, 25a . . . First separator member, 25b . . . Second separator member, 26 . . . Electrode, which is negative electrode in this embodiment, 28 . . . Negative-electrode active material layer, 30a . . . Protruding portion, 31 . . . Coupling portion, which is joint in this embodiment, 131d, 131f, 132d, 132f . . . Long sides.

1-9. (canceled)

10. An electricity storage device comprising:
an electrode assembly that is configured by stacking two electrodes each having an active material layer and a separator located between the electrodes, the electrode assembly having rectangular flat surfaces on opposite ends in a stacking direction; and
a case that accommodates the electrode assembly, wherein
the case includes rectangular walls that face the flat surfaces of the electrode assembly, and the separator has stretchabilities according to directions,
the stretchability of the separator in a longitudinal direction is higher than the stretchability in a transverse direction,
the separator includes a direction in which the stretchability of the separator is higher than the stretchabilities in other directions,
the separator is arranged such that the direction in which the stretchability is high is aligned with the direction with which long sides of the walls are aligned, and
the separator is an electrode-accommodating separator, which sandwiches one of the electrodes from opposite sides in the stacking direction to accommodate the electrode inside the separator.

11. The electricity storage device according to claim 10, wherein
the separator is configured by coupling separator members, which are opposed to each other with one of the electrodes sandwiched in between from the stacking direction,
each separator member includes a protruding portion, which protrudes from an outline of the sandwiched electrode, and
the separator includes a coupling portion, which couples at least a part of the protruding portions that are opposed to each other.

12. The electricity storage device according to claim 10, wherein an outline of the separator is aligned with an outline of the electrode that is not accommodated inside the separator as viewed from the stacking direction.

13. The electricity storage device according to claim 10, wherein an edge of the separator is exposed.

14. The electricity storage device according to claim 10, wherein
the electrodes include a negative electrode, and
the separator and the negative electrode are located in a range in which the separator and the negative electrode do not overlap as viewed in a plane direction of the negative electrode.

15. The electricity storage device according to claim 10, wherein
the separator is arranged such that the stretchability in one of orthogonal biaxial directions along a surface of the separator is higher than the stretchability in the other direction, and the direction in which the stretchability is higher is aligned with the direction with which long sides of the walls are aligned.

16. An electricity storage device comprising:
an electrode assembly that is configured by stacking electrodes each having an active material layer and a separator located between the electrodes, the electrode assembly having rectangular flat surfaces on opposite ends in a stacking direction; and
a case that accommodates the electrode assembly, wherein
the case has rectangular walls that face the flat surfaces of the electrode assembly, the separator includes a direction in which a stretchability of the separator is higher than stretchabilities in other directions,
the separator is arranged such that the direction in which the stretchability is high is aligned with the direction with which long sides of the walls are aligned,
the separator includes a first separator member and a second separator member, which sandwich one of the electrodes from opposite sides in the stacking direction, and
the first separator member and the second separator member are joined at a joint, and the electrode is accommodated inside the joint.

17. The electricity storage device according to claim 10, wherein the electricity storage device is a rechargeable battery.

18. An electricity storage device comprising:
an electrode assembly that is configured by stacking two electrodes each having an active material layer and a separator located between the electrodes, the electrode assembly having rectangular flat surfaces on opposite ends in a stacking direction; and
a case that accommodates the electrode assembly, wherein
the case includes rectangular walls that face the flat surfaces of the electrode assembly, and the separator has stretchabilities according to directions,
the stretchability of the separator in a longitudinal direction is higher than the stretchability in a transverse direction,
the separator is configured by biaxial stretching, in which separator material is stretched in two directions orthogonal to each other, and
the separator is arranged such that the stretchability in one of orthogonal biaxial directions along a surface of the separator is higher than the stretchability in the other direction, and the direction in which the stretchability is higher is aligned with the direction with which long sides of the walls are aligned.
